(19) United States
(12) Patent Application Publication
(10) Pub. No.: US 2008/0111323 A1
(43) Pub. Date: May 15, 2008

(54) Bit holders

(75) Inventor: Jason Dean Braunberger, Clackamas, OR (US)

Correspondence Address: KOLISCH HARTWELL, P.C., 520 SW YAMHILL STREET, Suite 200, PORTLAND, OR, 97204, US

(73) Assignee: WestPort Medical, Inc.

(21) Appl. No.: 11/595,540

(22) Filed: Nov. 9, 2006

(51) Int. Cl. B23B 31/16

(52) U.S. Cl. 279/75

(57) ABSTRACT

A holder for a bit is disclosed. The holder may include a base assembly, a second locking element, a follower assembly, and a bias assembly. In some embodiments the bias assembly may be configured to urge the bit away from a hole of the base assembly. In some embodiments, the bias assembly may move the follower assembly from a second position in which the follower assembly allows the second locking element to move from a locking position to an unlocking position, to a first position in which the follower assembly supports the second locking element in the locking position, when the bit is inserted in the second hole against urging from the bias assembly. In some embodiments, the bias assembly may be configured to urge the follower assembly away from the first position.

### BACKGROUND OF THE DISCLOSURE

Various powered and/or manual instruments may use one or more removable tool bits, which may have different shapes and/or designs to accomplish different tasks. The instruments typically will include a bit holder to removably hold and/or secure one or more of the bits. Some bit holders may require an external device, such as a key, to secure and/or unsecure the bit to the bit holder. Other bit holders may require manipulation by the user to secure and/or unsecure the desired bit to the bit holder. For example, a conventional three-jaw chuck requires the user to loosen the jaws to insert or remove the bit and to tighten the jaws to secure the bit. Alternatively, bit holders may automatically secure and/or lock the bit when the user inserts the bit into the bit holder.

### SUMMARY OF THE DISCLOSURE

Some embodiments provide a holder for a bit. The bit may include a first locking element. The holder may include a base assembly including a first hole and a second hole sized to receive a portion of the bit; a second locking element partially disposed within the first hole and configured to move between a locking position in which the second locking element engages the first locking element to prevent removal of the bit from the second hole of the base assembly, and an unlocking position in which the second locking element is spaced from the first locking element allowing the bit to be removed from the second hole of the base assembly; a follower assembly operatively connected to the base assembly and configured to move between a first position in which the follower assembly supports the second locking element in the locking position, and a second position in which the follower assembly allows the second locking element to move from the locking position to the unlocking position; and a bias assembly operatively connected to the follower assembly and configured to urge the bit away from the second hole and to move the follower assembly from the second position to the first position when the bit is inserted in the second hole against urging from the bias assembly.

Some embodiments provide a holder for a bit. The bit may include at least one groove. The holder may include a base assembly including at least one radial hole and a longitudinal hole sized to receive a portion of the bit; at least one ball partially disposed within the at least one radial hole and configured to move between a locking position in which the at least one ball engages the at least one groove to prevent removal of the bit from the longitudinal hole of the base assembly, and an unlocking position in which the at least one ball is spaced from the at least one groove allowing the bit to be removed from the longitudinal hole of the base assembly; a follower assembly slidingly connected to the base assembly and configured to move between a first position in which the follower assembly supports the at least one ball in the locking position, and a second position in which the follower assembly allows the at least one ball to move from the locking position to the unlocking position; and a bias element operatively connected to the follower assembly and configured to urge the bit away from the longitudinal hole and to move the follower assembly from the second position to the first position when the bit is inserted in the longitudinal hole of the base assembly against urging from the bias element.

Some embodiments provide a holder for a bit. The bit may include at least one groove. The holder may include a base assembly including a plurality of radial holes and a longitudinal hole sized to receive a portion of the bit and; at least three balls each partially disposed within one of the plurality of radial holes, the at least three balls configured to move between a locking position in which the at least three balls engage the at least one groove to prevent removal of the bit from the longitudinal hole of the base assembly, and an unlocking position in which the at least three balls are spaced from the at least one groove allowing the bit to be removed from the longitudinal hole of the base assembly; a sleeve slidingly connected to the base assembly and configured to move between a first position in which the sleeve supports the at least three balls in the locking position, and a second position in which the sleeve allows the at least three balls to move from the locking position to the unlocking position; and a coil spring operatively connected to the sleeve and configured to urge the bit away from the longitudinal hole, to urge the sleeve away from the first position, and to move the sleeve from the second position to the first position when the bit is inserted in the longitudinal hole of the base assembly against urging from the coil spring.

### BRIEF DESCRIPTION OF THE DRAWINGS

FIG. 1 is a powered surgical instrument having a bit holder.

FIG. 2 is an exploded view of an illustrative example of a bit holder of the powered surgical instrument of FIG. 1.

FIG. 3 is a sectional view of the bit holder of FIG. 2 taken along lines 3-3 in FIG. 1, showing the bit holder before a bit is inserted.

FIG. 4 is the sectional view of FIG. 3, showing the bit partially inserted and contacting one or more locking elements of the bit holder.

FIG. 5 is the sectional view of FIG. 3, showing the bit partially inserted and contacting a bias element of the bit holder.

FIG. 6 is the sectional view of FIG. 3, showing the bit inserted and secured to the bit holder.

FIG. 7 is a sectional view of another illustrative example of a bit holder of the powered surgical instrument of FIG. 1 taken along lines 3-3 in FIG. 1, showing the bit holder before a bit is inserted.

FIG. 8 is the sectional view of FIG. 7, showing the bit partially inserted and contacting one or more locking elements of the bit holder.

FIG. 9 is the sectional view of FIG. 7, showing the bit partially inserted and contacting a bias element of the bit holder.

FIG. 10 is the sectional view of FIG. 7, showing the bit inserted and secured to the bit holder.

### DETAILED DESCRIPTION OF THE DISCLOSURE

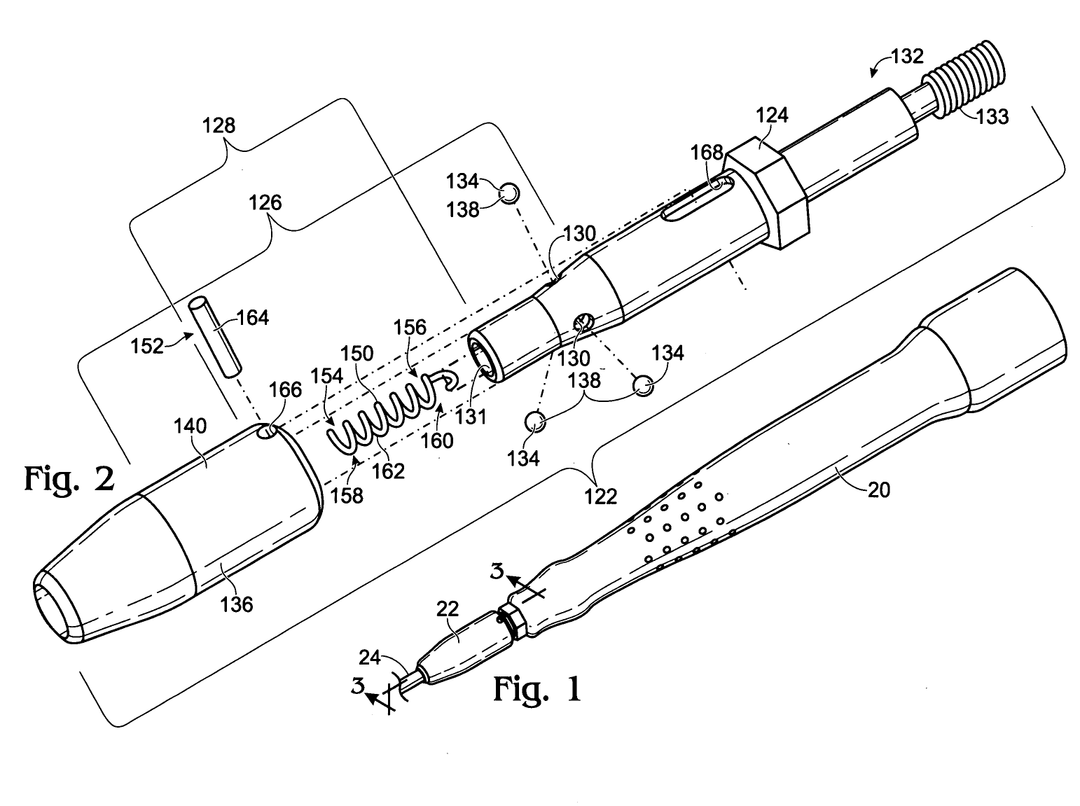

FIG. 1 depicts a powered surgical instrument 20 having a bit holder 22 that removably secures a bit 24. The powered surgical instrument may have any suitable structure and/or may have any suitable function(s). For example, powered surgical instrument 20 may include at least some of the components described in U.S. Patent Application Publication No. 2006/0014119. The complete disclosure of that application is hereby incorporated by reference for all purposes. Although powered surgical instrument 20 is shown to include bit holder 22, any suitable powered and/or manual instrument may include the bit holder.

Bit 24 may include one or more first locking elements 26, which may include any suitable structure configured to interact with one or more locking mechanisms of the bit holder. For example, first locking elements 26 may include one or more indentations, depressions, or grooves 28, as shown in FIG. 4. Grooves 28 may include any suitable shape(s). For example, the grooves may include approximately capsule-like depressions, such as the grooves shown in U.S. Design Patent Application Serial No. ______ entitled “Bit for a Powered Surgical Instrument,” filed on Oct. 19, 2006. The complete disclosure of that application is hereby incorporated by reference for all purposes.

Although first locking elements 26 are shown to include one or more indentations or grooves 28, the first locking elements may include any suitable structure configured to interact with one or more locking mechanisms of the bit holder. For example, first locking elements 26 may alternatively, or additionally, include one or more ridges, one or more ribs, etc. Additionally, although grooves 28 are shown to include approximately capsule-like depressions, the grooves may include any suitable shape(s).

Moreover, although first locking elements 26 are shown to include six grooves, the first locking elements may include more or less grooves. For example, first locking elements 26 may include at least one groove. Furthermore, although grooves 28 are shown to include discrete shapes, the grooves may alternatively, or additionally, include one or more continuous shape(s), such as one or more circumferential grooves. Additionally, although grooves 26 are shown to be adjacent to each other, one or more of the grooves may be spaced from each other at any suitable distance(s).

An illustrative example of bit holder 22 is shown in FIGS. 2-6 and is generally indicated at 122. Bit holder 122 may include any suitable structure configured to removably secure one or more bits to the powered surgical instrument or any suitable instrument. Additionally, bit holder 122 may include any suitable structure configured to automatically secure and/or lock the bit when the user inserts the bit into the bit holder. For example, bit holder 122 may include at least one base assembly 124, at least one locking mechanism 126, and at least one bias assembly 128.

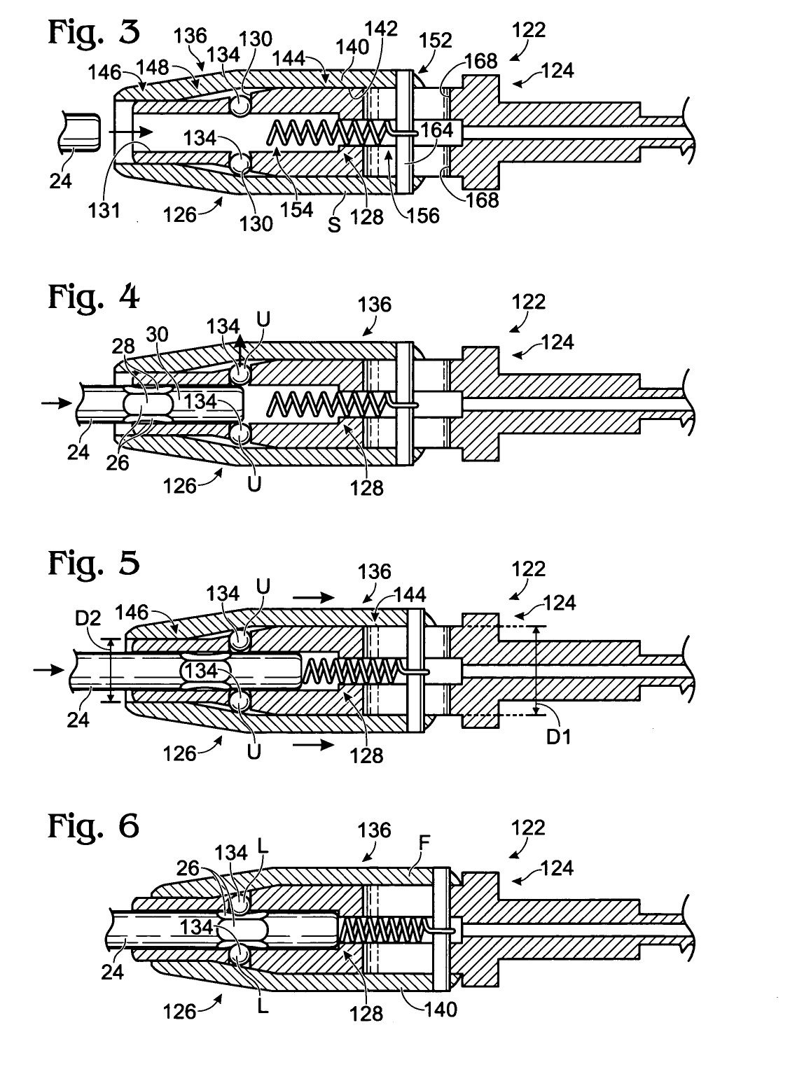

The base assembly may include any suitable structure configured to support bit 24. For example, base assembly 124 may include one or more first holes 130, at least one second hole 131, and at least one instrument connecting portion 132, as shown in FIG. 2. The first holes may be configured to support one or more components of the locking mechanism, such as one or more locking elements as further discussed below. First holes 130 may be sized to allow movement of one or more of the locking elements within any suitable range(s) and/or direction(s). For example, the first holes may be sized to allow one or more of the locking elements to move radially without falling into the second hole, as shown in FIG. 3. In some embodiments, the first holes may be bored partially through the base assembly to locate the locking elements.

First holes 130 may include any suitable number of holes, such as three holes as shown in FIG. 2. Additionally, when first holes 130 include two or more holes, those holes may be spaced from each other at any suitable distance(s). Second hole 131 may be sized to receive at least a portion of the bit, such as an end portion 30 of bit 24, as shown in FIGS. 3-4.

First holes 130 and/or second hole 131 may have any suitable orientation(s). For example, the first holes may be oriented in the radial direction of the bit holder (also may be referred to as radial holes). Additionally, or alternatively, second hole 131 may be oriented in the longitudinal direction of the bit holder (also may be referred to as a longitudinal hole).

Instrument connecting portion 132 may include any suitable structure configured to connect base assembly 124 to the powered surgical instrument. For example, the connecting portion may include one or more threaded sections 133. Although instrument connecting portion 133 is shown to include threaded sections 133, the instrument connecting portion may alternatively, or additionally, include any suitable structure configured to connect the base assembly to the powered surgical instrument.

Although base assembly 124 is shown to include first holes 130 and second hole 131, the base assembly may include any suitable number of holes that may be more or less than the holes shown in FIG. 2. For example, base assembly may include a single first hole 130 and a single second hole 131. Additionally, although first holes 130 are shown to be oriented in the radial direction, the first holes may alternatively, or additionally, be oriented in any suitable direction(s), such as a longitudinal direction. Moreover, although second hole 131 is shown to be oriented in the longitudinal direction, the second hole may be oriented in any suitable direction(s), such as a radial direction.

Furthermore, although base assembly 124 is shown to include particular structure, the base assembly may alternatively, or additionally, include any suitable structure. For example, base assembly 124 may include at least one collet (not shown), which may include a second hole (not shown) sized to receive at least a portion of the bit, such as an end portion 30 of bit 24. In some embodiments, the use of a collet may enable the bit holder to accept bits with different diameters.

Locking mechanism 126 may include any suitable structure configured to secure the bit to base assembly 124. For example, the locking mechanism may include one or more second locking elements 134 and at least one follower assembly 136, as shown in FIG. 2. The second locking elements may be at least partially disposed within one or more of the first holes of the base assembly.

Additionally, second locking elements 134 may move within the first holes among a plurality of positions, as shown in FIGS. 3-6. For example, second locking elements 134 may move between a locking position L in which one or more of the second locking elements may engage at least a portion of one or more of the first locking elements to prevent removal of the bit from the second hole of the base assembly, and an unlocking position U in which one or more of the second locking elements may be spaced from one or more of the first locking elements allowing the bit to be removed from the second hole of the base assembly.

Second locking elements 134 may include any suitable structure configured to engage at least a portion of first locking element 26. For example, second locking elements 134 may include at least one interference member, such as at least one ball 138. The second locking elements may include any suitable number of balls. For example, second locking elements 134 may include three balls, as shown in FIG. 2.

Although second locking elements 134 are shown to be configured to move between locking position L and unlocking position U, one or more of the second locking elements may alternatively, or additionally, be configured to move among other suitable position(s). Additionally, although second locking elements 134 are shown to include balls 138, the second locking elements may include any suitable structure configured to engage at least a portion of one or more of the first locking elements. For example, second locking elements 134 may alternatively, or additionally, include one or more pins, one or more levers, one or more arms, one or more disks, etc.

Moreover, although second locking elements 134 are shown to include three balls 138, the second locking elements may include any suitable number of balls, which may be more or less than the balls shown. Furthermore, although each ball 138 is shown to be at least partially disposed within a different first hole 130, two or more of the balls may be partially disposed within one or more of the first holes 130.

Follower assembly 136 may be movably and/or operatively connected to the base assembly and may be configured to move relative to the base assembly among a plurality of positions. For example, follower assembly 136 may be configured to move between a first position F in which the follower assembly may support one or more of the second locking elements in the locking position, and a second position S in which the follower assembly may allow one or more of the second locking elements to move from the locking position to the unlocking position, as shown in FIGS. 3-6.

The follower assembly may be movably connected to the base assembly in any suitable way(s). For example, follower assembly 136 may be slidingly connected to the base assembly such that the follower assembly slides among one or more of the plurality of positions. Although follower assembly 136 is shown to be configured to move between the first position and the second position, the follower assembly may alternatively, or additionally, be configured to move among one or more other suitable positions. Additionally, although follower assembly 136 is shown to be slidingly connected to base assembly 124, the follower assembly may alternatively, or additionally, be pivotally connected, rotatingly connected, and/or connected in other suitable way(s).

Follower assembly 136 may include any suitable structure configured to move one or more of the second locking elements and/or allow one or more of the second locking elements to move among the plurality of positions, such as between locking position L and unlocking position U. For example, follower assembly 136 may include at least one sleeve 140.

Sleeve 140 may include at least one internal surface or wall 142, which may include a first portion 144, a second portion 146, and at least one sloped transition portion 148. The first and/or second portions may have any suitable diameter(s). For example, first portion 144 may have a first diameter D1 and second portion 146 may have a second diameter D2. First diameter D1 may be larger than second diameter D2, as shown in FIG. 5. Alternatively, the first diameter may be equal to or smaller than the second diameter.

Sloped transition portion 148 may be disposed between first portion 144 and second portion 146. Additionally, or alternatively, the sloped transition portion may contact one or more of the second locking elements. Alternatively, or additionally, sloped transition portion 148 may move one or more of the second locking elements from the unlocking position to the locking position when the sleeve is moved from the second position to the first position. The sloped transition portion also may be referred to as a slanted internal surface.

Additionally, or alternatively, the sloped transition portion may be spaced from one or more of the second locking elements when the sleeve in the second position. In some embodiments, movement of the sleeve from the first position to the second position may allow one or more of the second locking elements to move from the locking position to the unlocking position because of, for example, urging of the bit away from the second hole by the bias assembly.

Although sleeve 140 is shown to include internal wall 142 with first portion 144, second portion 146, and sloped transition portion 148, the sleeve may include any suitable structure configured to move and/or allow one or more of the second locking elements to move between the locking position and the unlocking position. For example, sleeve 140 may include one or more balls, one or more arms, and/or one or more levers. Additionally, although follower assembly 136 is shown to include sleeve 140, the follower assembly may include any suitable structure configured to move and/or allow one or more of the second locking elements to move between the locking position and the unlocking position.

Bias assembly 128 may be operatively connected to the base assembly and may include any suitable structure configured to urge bit 24 away from second hole 131. In some embodiments, the bias assembly may eject the bit either partially or completely away from the base assembly. In those embodiments, ejecting the bit either partially or completely away may eliminate the need to manually remove and/or handle the bit, such as a contaminated bit.

Additionally, or alternatively, the bias assembly may include any suitable structure configured to move follower assembly 136 from second position S to first position F when the bit is inserted in the second hole against urging from the bias assembly. Alternatively, or additionally, bias assembly 128 may include any suitable structure configured to urge the follower assembly away from the first position.

For example, bias assembly 128 may include at least one bias element 150 and at least one connecting assembly 152, as shown in FIG. 2. At least a substantial portion of the bias element may be contained within second hole 131 of base assembly 124. Additionally, or alternatively, at least a portion of bias element 150 may be unrestrained, such as when end portion 30 of bit 24 is not in contact with the bias element. “Unrestrained,” as used herein, refers to the bias element or portion(s) of the bias element in its relaxed state and/or not having any stored energy. For example, when the bias element includes a coil spring, the coil spring or portion(s) of the coil spring is unrestrained when the coil spring or portion(s) of the coil spring is neither compressed nor stretched.

Although bias element 150 is shown to be at least substantially contained within second hole 131, the bias element may be in any suitable location(s) in the bit holder. Additionally, although at least a portion of bias element 150 is shown to be unrestrained when end portion 30 of bit 24 is not in contact with bias element 150, the bias element or portion(s) of the bias element may be restrained when the end portion of the bit is not in contact with the bias element.

Bias element 150 may include a first portion 154 and a second portion 156 spaced from the first portion, as shown in FIG. 2. First portion 154 may be configured to contact end portion 30 of bit 24. For example, the first portion may include a first end portion 158 of the bias element. Second portion 156 may include a second end portion 160 of bias element 150. The second portion may be operatively connected to follower assembly 136.

Bias element 150 may include any suitable structure configured to urge bit 24 away from second hole 131 and/or to urge the follower assembly away from the first position. For example, bias element 150 may include a coil spring 162, as shown in FIG. 2. Although bias element 150 is shown to include coil spring 162, the bias element may include any suitable structure, such as leaf springs, spiral springs, cantilever springs, Belleville springs, spring washers, torsion springs, gas springs, rubber bands, etc. Additionally, although bias assembly 124 is shown to include a single bias element 150, the bias assembly may include two or more bias elements.

Connecting assembly 152 may include any suitable structure configured to connect second portion 156 of bias element 150 to follower assembly 136. For example, the connecting assembly may include at least one pin 164, as shown in FIG. 2. The pin may be received within one or more holes 166 of follower assembly 136, and/or may be received within one or more slots 168 of base assembly 124, as shown in FIGS. 2-6. In some embodiments, one or more of the slots may limit the range of movement of the connecting assembly, which also may limit the range of movement of the follower assembly.

Although connecting assembly 152 is shown to include pin 164, the connecting assembly may include any suitable structure configured to connect second portion 156 of bias element 150 to follower assembly 136. Additionally, although bias element 150 is shown to be operatively connected to follower assembly 136 via connecting assembly 152, the bias element may alternatively be directly connected to the follower assembly. For example, second portion 156 may be connected to the follower assembly.

Moreover, although second portion 156 of bias element 150 is shown directly connected to pin 164, the connecting assembly may include one or more intermediate structures that connect the second portion to the pin. For example, connecting assembly 152 may include a ring (not shown) that connects the second portion to the pin. Furthermore, although bias assembly 128 is shown to include bias element 150 and connecting assembly 152, the bias assembly may include any suitable structure configured to urge bit 24 away from second hole 131, move follower assembly 136 from second position S to first position F when the bit is inserted in the second hole against urging from the bias assembly, and/or urge the follower assembly away from the first position.

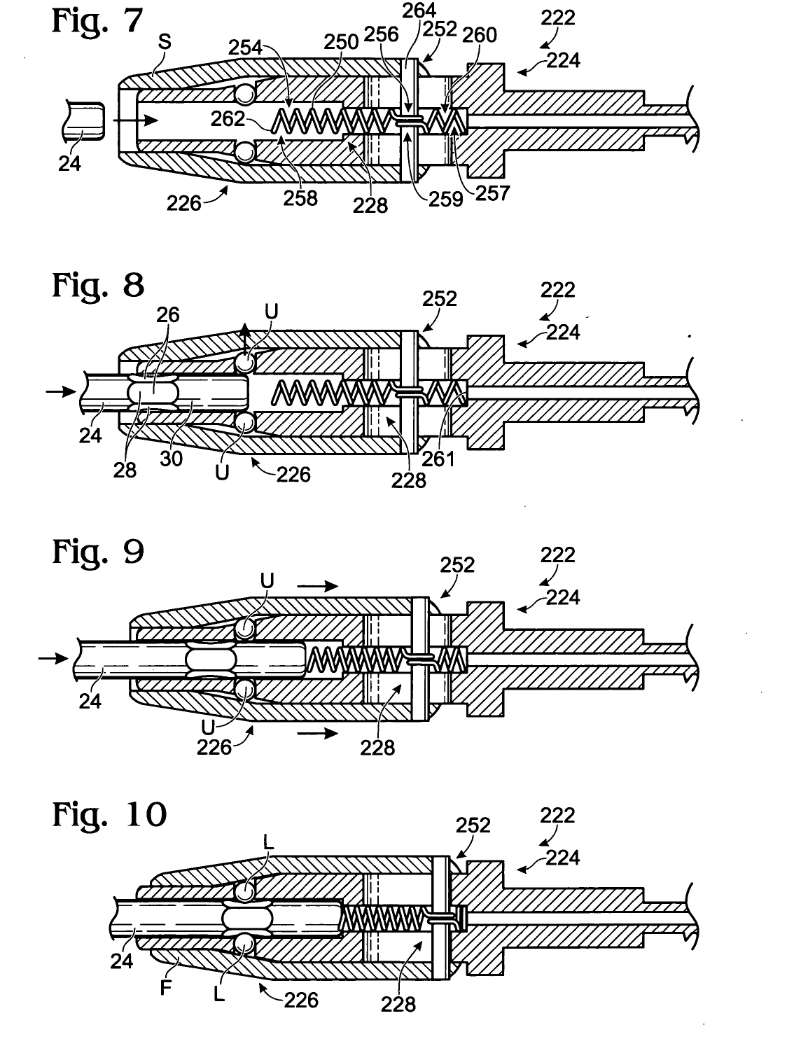

Although base assembly 124, locking mechanism 126, and bias assembly 126 are shown to be discrete assemblies of bit holder 122, one or more of those assemblies may have one or more common components. For example, bias element 150 and/or pin 164 of bias assembly 126 may be incorporated and/or formed with sleeve 40 of follower assembly 136. Incorporating one or more components with other components may be accomplished through any suitable process(es), such as injection molding and/or machining. Additionally, although bit holder 122 is shown to include base assembly 124, locking mechanism 126, and bias assembly 128, the bit holder may alternatively, or additionally, include any suitable structure configured to removably secure one or more bits to the powered surgical instrument. For example, FIGS. 7-10 show another illustrative example of bit holder 22, which is generally indicated at 222. Unless otherwise indicated, bit holder 222 may include at least some of the components of bit holder 122.

Bit holder 222 may include at least one base assembly 224, at least one locking mechanism 226, and at least one bias assembly 228. The base assembly and/or the locking mechanism may include at least some of the components of the base assembly and/or the locking mechanism of bit holder 122.

Bias assembly 228 may be operatively connected to the base assembly and may include any suitable structure configured to urge bit 24 away from the second hole of base assembly 228. Additionally, or alternatively, the bias assembly may include any suitable structure configured to move the follower assembly of locking mechanism 226 from second position S to first position F when the bit is inserted in the second hole against urging from the bias assembly. Alternatively, or additionally, bias assembly 228 may include any suitable structure configured to urge the follower assembly away from the first position.

For example, bias assembly 228 may include at least one bias element 250 and at least one connecting assembly 252, as shown in FIGS. 7-10. Bias element 250 may include a first portion 254, a second portion 256 spaced from the first portion, and a third portion 257 spaced from the first and/or second portions.

First portion 254 may be configured to contact an end portion 30 of bit 24. For example, the first portion may include a first end portion 258 of the bias element. Second portion 256 may include an intermediate portion 259 of bias element 250. The second portion may be operatively connected to the follower assembly. Third portion 257 may include a second end portion 260 of the bias element. The third portion may be located adjacent an end 261 of the second hole of the base assembly, as shown in FIGS. 7-10.

Bias element 250 may include any suitable structure configured to urge bit 24 away from the second hole and/or to urge the follower assembly away from the first position. For example, bias element 250 may include a coil spring 262, as shown in FIGS. 7-10. Although bias element 250 is shown to include coil spring 262, the bias element may include any suitable structure, such as leaf springs, spiral springs, cantilever springs, Belleville springs, spring washers, torsion springs, gas springs, rubber bands, etc.

Additionally, although bias assembly 224 is shown to include a single bias element 250, the bias assembly may include two or more bias elements. For example, a first bias element may be connected to the connecting assembly and may urge the bit away from the second hole. Additionally, or alternatively, a second bias element may be connected to the connecting assembly (and/or may be adjacent to end 261 of the second hole of the base assembly) and may urge the follower away from the first position.

Connecting assembly 252 may include any suitable structure configured to connect second portion 256 of bias element 250 to the follower assembly. For example, the connecting assembly may include at least one pin 264, as shown in FIGS. 7-10. The pin may be received within one or more holes of the follower assembly, and/or may be received within one or more slots of the base assembly. Although second portion 256 is shown to be directly connected to pin 264, connecting assembly 252 may include one or more intermediate structures that connect the second portion to the pin.

To insert a bit and secure it to the bit holder, a user may move the follower assembly to second position S, as shown in FIG. 3, before inserting the bit in the second hole of the bit holder. Alternatively, the follower assembly may be in the second position because of urging from the bias assembly, as shown in FIG. 7. In the second position, at least a portion of the bias element may be unrestrained and/or the follower assembly may allow one or more of the second locking elements to move between the locking and unlocking positions. When the bit is inserted, the end portion of the bit may contact and/or move one or more of the second locking elements to the unlocking position, as shown in FIGS. 4 and 8, and may contact the first portion of the bias element, as shown in FIGS. 5 and 9.

As the bit is further inserted, the end portion of the bit may push the first portion of the bias element, against urging from the bias element, such that the follower assembly may move towards first position F. As the follower assembly is being moved towards the first position, the follower assembly may move one or more of the second locking elements to the locking position such that those elements engage the first locking element of the bit, as shown in FIGS. 6 and 10.

To release the bit, a user may move the follower assembly to second position S. In the second position, the follower assembly may allow the bias element to urge one or more of the second locking elements towards the unlocking position, such as via the bias element urging the bit away from the second hole. When the second locking elements are in the unlocking position, the bias element may move and/or may eject the bit away from the second hole. However, the steps discussed above may be performed in different sequences and in different combinations, not all steps being required for all embodiments of the bit holder.

Although bit holders and features of bit holders have been shown and described with reference to the foregoing operational principles and preferred embodiments, those skilled in the art will find apparent that various changes in form and detail may be made without departing from the spirit and scope of the claims. The present disclosure is intended to embrace all such alternatives, modifications, and variances that fall within the scope of the appended claims.

What is claimed is:

1. A holder for a bit, the bit including a first locking element, comprising:
a base assembly including a first hole and a second hole sized to receive a portion of the bit;
a second locking element partially disposed within the first hole and configured to move between a locking position in which the second locking element engages the first locking element to prevent removal of the bit from the second hole of the base assembly, and an unlocking position in which the second locking element is spaced from the first locking element allowing the bit to be removed from the second hole of the base assembly;
a follower assembly operatively connected to the base assembly and configured to move between a first position in which the follower assembly supports the second locking element in the locking position, and a second position in which the follower assembly allows the second locking element to move from the locking position to the unlocking position; and
a bias assembly operatively connected to the follower assembly and configured to urge the bit away from the second hole and to move the follower assembly from the second position to the first position when the bit is inserted in the second hole against urging from the bias assembly.

2. The holder of claim 1, wherein the second locking element includes a ball configured to engage the first locking element in the locking position.

3. The holder of claim 1, wherein the first hole includes a radial hole.

4. The holder of claim 3, wherein the second hole includes a longitudinal hole.

5. The holder of claim 1, wherein the follower assembly includes a sleeve slidingly connected to the base assembly.

6. The holder of claim 5, wherein the sleeve includes an internal wall, the internal wall including a first portion having a first diameter, a second portion spaced from the first portion and having a second diameter that is smaller than the first diameter of the first portion, and a sloped transition portion disposed between the first and second portions, wherein the sloped transition portion contacts the second locking element and moves the second locking element from the unlocking position to the locking position when the sleeve is moved from the second position to the first position.

7. The holder of claim 6, wherein the sloped transition portion is spaced from the second locking element when the sleeve is in the second position allowing the second locking element to move from the locking position to the unlocking position.

8. The holder of claim 1, wherein the bias assembly includes a bias element including a first portion and a second portion spaced from the first portion, the second portion is operatively connected to the follower assembly and the first portion is configured to be contacted by an end portion of the bit when the bit is inserted into the second hole.

9. The holder of claim 8, wherein the bias assembly further includes a connecting assembly that connects the second portion of the bias element to the follower assembly.

10. The holder of claim 8, wherein at least a substantial portion of the bias element is contained within the second hole of the base assembly.

11. The holder of claim 8, wherein the bias element includes a coil spring.

12. The holder of claim 8, wherein the first portion includes a first end portion of the bias element.

13. The holder of claim 12, wherein the second portion includes a second end portion of the bias element.

14. The holder of claim 12, wherein the second portion includes an intermediate portion of the bias element.

15. The holder of claim 1, wherein the bias assembly is further configured to urge the follower assembly away from the first position, and to move the follower assembly from the second position to the first position when the bit is inserted in the second hole against urging from the bias assembly.

16. A holder for a bit, the bit including at least one groove, comprising:
a base assembly including at least one radial hole and a longitudinal hole sized to receive a portion of the bit;
at least one ball partially disposed within the at least one radial hole and configured to move between a locking position in which the at least one ball engages the at least one groove to prevent removal of the bit from the longitudinal hole of the base assembly, and an unlocking position in which the at least one ball is spaced from the at least one groove allowing the bit to be removed from the longitudinal hole of the base assembly;
a follower assembly slidingly connected to the base assembly and configured to move between a first position in which the follower assembly supports the at least one ball in the locking position, and a second position in which the follower assembly allows the at least one ball to move from the locking position to the unlocking position; and
a bias element operatively connected to the follower assembly and configured to urge the bit away from the longitudinal hole and to move the follower assembly from the second position to the first position when the bit is inserted in the longitudinal hole of the base assembly against urging from the bias element.

17. The holder of claim 16, wherein the at least one ball includes a first ball, a second ball, and a third ball.

18. The holder of claim 17, wherein the at least one radial hole includes a first radial hole, a second radial hole, and a third radial hole, and wherein the first ball is partially disposed within the first radial hole, the second ball is partially disposed within the second radial hole, and the third ball is partially disposed within the third radial hole.

19. The holder of claim 16, wherein the bias element includes a first portion and a second portion spaced from the first portion, the second portion is operatively connected to the follower assembly and the first portion is configured to be contacted by an end portion of the bit when the bit is inserted into the longitudinal hole.

20. The holder of claim 19, wherein at least the first portion is unrestrained when the end portion of the bit is not in contact with the first portion.

21. The holder of claim 19, further comprising a connecting assembly configured to connect the second portion of the bias element to the follower assembly.

22. The holder of claim 16, wherein the bias element is further configured to urge the follower assembly away from the first position.

23. A holder for a bit, the bit including at least one groove, comprising:
a base assembly including a plurality of radial holes and a longitudinal hole sized to receive a portion of the bit and;
at least three balls each partially disposed within one of the plurality of radial holes, the at least three balls configured to move between a locking position in which the at least three balls engage the at least one groove to prevent removal of the bit from the longitudinal hole of the base assembly, and an unlocking position in which the at least three balls are spaced from the at least one groove allowing the bit to be removed from the longitudinal hole of the base assembly;
a sleeve slidingly connected to the base assembly and configured to move between a first position in which the sleeve supports the at least three balls in the locking position, and a second position in which the sleeve allows the at least three balls to move from the locking position to the unlocking position; and
a coil spring operatively connected to the sleeve and configured to urge the bit away from the longitudinal hole, to urge the sleeve away from the first position, and to move the sleeve from the second position to the first position when the bit is inserted in the longitudinal hole of the base assembly against urging from the coil spring.

24. The holder of claim 23, wherein the sleeve includes an internal wall, the internal wall including a first portion having a first diameter, a second portion spaced from the first portion and having a second diameter that is smaller than the first diameter, and a sloped transition portion disposed between the first and second portions, and wherein the sloped transition portion contacts the at least three balls and moves the at least three balls from the unlocking position to the locking position when the sleeve is moved from the second position to the first position.

25. The holder of claim 24, wherein the sloped transition portion is spaced from the at least three balls when the sleeve is in the second position allowing the at least three balls to move from the locking position to the unlocking position.
